(19) United States
(12) Patent Application Publication
(10) Pub. No.: US 2024/0413703 A1
(43) Pub. Date: Dec. 12, 2024

(54) METHOD AND APPARATUS OF AXIAL FASTENING FOR ROTATING ELECTRIC MACHINES

(71) Applicant: BorgWarner Inc., Auburn Hills, MI (US)

(72) Inventor: Timothy Alfermann, Carmel, IN (US)

(21) Appl. No.: 18/734,348

(22) Filed: Jun. 5, 2024

Related U.S. Application Data
(60) Provisional application No. 63/506,441, filed on Jun. 6, 2023.

(51) Int. Cl. H02K 7/00

(52) U.S. Cl. CPC H02K 7/003; H02K 7/006

(57) ABSTRACT

A vehicle includes an engine and an electric machine connected to the engine. The engine includes a drive shaft defining an axial centerline and an engine adapter connected to an end of the drive shaft. The engine adapter includes a mount with a plurality of mounting holes, a plurality of bolts extending through the plurality of mounting holes and into the drive shaft, and a central end knob positioned along the axial centerline. The electric machine includes a stator, a rotor and a rotor shaft extending along the axial centerline. The rotor shaft defines a cup structure at an end of the rotor shaft with the central end knob of the engine adapter positioned within the cup structure. A central bolt extends between the rotor shaft and the engine drive shaft.

### CROSS-REFERENCE TO RELATED APPLICATIONS

The present application claims priority to U.S. provisional patent application No. 63/506,441, filed Jun. 6, 2023, the entire contents of which is incorporated herein by reference.

### FIELD

This application relates to the field of electric machines and particularly to rotating electric machines in direct drive applications.

### BACKGROUND

Attachment of an electric machine to an engine is commonly performed by starter ring gear attachments to transmissions or flex plates. These attachments often involve multiple bolts around the circumference which have to be installed through rotation of the engine. Other methods include the use of flex couples typically used in test dynamometers which secure through radial fastening of the coupler. Some internal solutions to transmissions may have wet splines which have dampers in the system to be able to handle engine torque oscillations.

Various problems are associated with these past methods and devices for attachment of the electric machine to the engine. For example, multiple bolts are required with requires numerous parts and procedures for attachment, and/or a large radius for attachment is required which affects solution packaging volume. Other examples of problems include the need to rotate the engine to fasten all bolts which takes more time during assembly, the need for a wet spline environment, and/or additional damper hardware needed to implement the procedure for attachment. While these issues are known, there is typically no other way to access the interface due to other constraints, so the prior art method and procedures for attachment have become standard in the industry.

In view of the foregoing, it would be advantageous to provide a low cost method and apparatus of attaching the electric machine to an engine. It would be advantageous if one or more embodiments of such methods and apparatus avoided axial stackup preventing a bolted connection, and required fewer bolts than the conventional methods and apparatus for attachment. It would also be advantageous if the time required for assembly were reduced, and dry spline wear was reduced.

### SUMMARY

In accordance with one or more embodiments of the disclosure, there is provided a vehicle comprising an engine with a drive shaft and an electric machine connected to the engine. The electric machine includes a stator, a rotor and a hollow rotor shaft defining an axial centerline. A central bolt extends between the hollow rotor shaft and the engine.

In at least one embodiment of the disclosure a vehicle includes an engine and an electric machine connected to the engine. The engine includes a drive shaft defining an axial centerline and an engine adapter connected to an end of the drive shaft. The engine adapter includes a mount with a plurality of mounting holes, a plurality of bolts extending through the plurality of mounting holes and into the drive shaft, and a central end knob positioned along the axial centerline. The electric machine includes a stator, a rotor and a rotor shaft extending along the axial centerline. The rotor shaft defines a cup structure at an end of the rotor shaft with the central end knob of the engine adapter positioned within the cup structure.

In one embodiment of the disclosure an engine adapter is configured to couple an electric machine to a drive shaft of a vehicle engine. The engine adapter includes a circular mounting plate with a plurality of mounting holes configured to pass a plurality of bolts through the circular mounting plate. The engine adapter also includes a knob positioned at a center of the mounting plate and extending outward from the mounting plate, the knob including a threaded bolt hole positioned at a distal end of the knob from the mounting plate. The engine adapter further includes a center bolt including a threaded shaft and a head, wherein the threaded bolt hole at the distal end of the knob is configured to receive the threaded shaft.

In view of the foregoing, it will be recognized that a low cost method and apparatus for attaching the electric machine to an engine is disclosed herein. The method and apparatus utilizes a hard connection through single bolted interference feature (wherein a damper may or may not be included). In at least some embodiments of the disclosure, an axial stack is achieved through wave washers, which avoids axial stackup and avoids a bolted connection. Instead of multiple bolts required, only one center bolt is utilized. By use of a singular bolt, the time required for assembly is reduced because no engine rotation is needed as is typically required when fastening the electric machine to the engine. Additionally, dry spline wear is reduced by the use of interference features and an associated bolt.

The above described features and advantages, as well as others, will become more readily apparent to those of ordinary skill in the art by reference to the following detailed description and accompanying drawings. While it would be desirable to provide a method and apparatus of axial fastening for rotating electric machines that provides one or more of these or other advantageous features, the teachings disclosed herein extend to those embodiments which fall within the scope of any eventually appended claims, regardless of whether they accomplish one or more of the above-mentioned advantages.

### BRIEF DESCRIPTION OF THE DRAWINGS

FIG. 1 shows a perspective view of a vehicle that incorporates a method and apparatus for axial fastening of an electric machine to a vehicle engine;

FIG. 2 shows a cross-sectional view of the electric machine of FIG. 1 attached to the vehicle engine;

FIG. 3 shows an enlarged view of a rotor shaft of the electric machine of FIG. 2 coupled to an engine adapter and an engine drive shaft;

FIG. 4 shows an alternative embodiment of the electric machine and engine adapter of FIG. 3 wherein a knob of the engine adapter has a conical shape;

FIG. 5 shows the engine adapter of FIG. 4; and

FIG. 6 shows an alternative embodiment of the rotor shaft and engine adapter of FIG. 3.

### DESCRIPTION

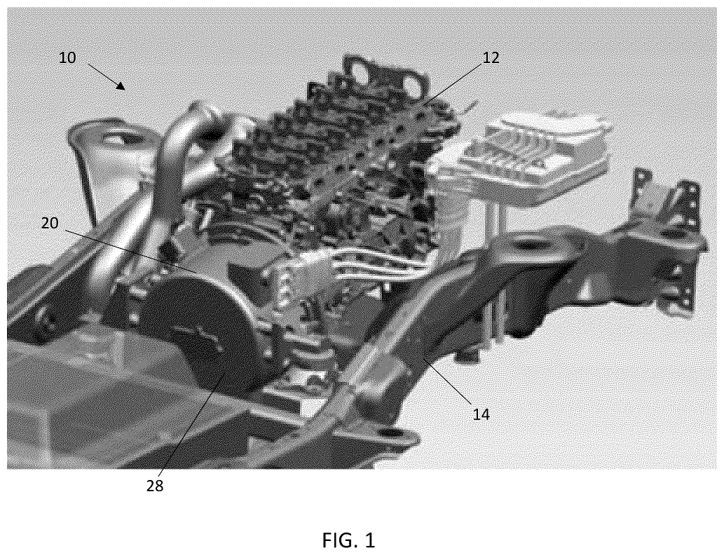

With general reference to FIGS. 1-3, a vehicle 10 is disclosed including a vehicle engine 12 and an electric machine 20, both carried by a vehicle chassis 14. The engine 12 is an internal combustion engine configured to propel the vehicle. The electric machine 20, may be configured for any of a number of different applications for the vehicle 10, such as a generator, a drive/propulsion application for a hybrid-electric vehicle and/or an engine starter. The vehicle 10 includes an axial fastening member that couples the electric machine 20 to the engine 12. In at least one embodiment, the axial fastening member is provided by an engine adapter 50 that is coupled between a drive shaft 16 of the engine 12 and a rotor shaft 26 of the electric machine 20. The engine adapter 50 includes a central end knob 60 that is received within a cavity 30 of the rotor shaft 26. A central shaft bolt 70 is used to firmly secure the end knob 60 within a cavity 30 of the rotor shaft 26.

Embodiment of Engine Adapter with Cylindrical Knob and Shaft Bolt

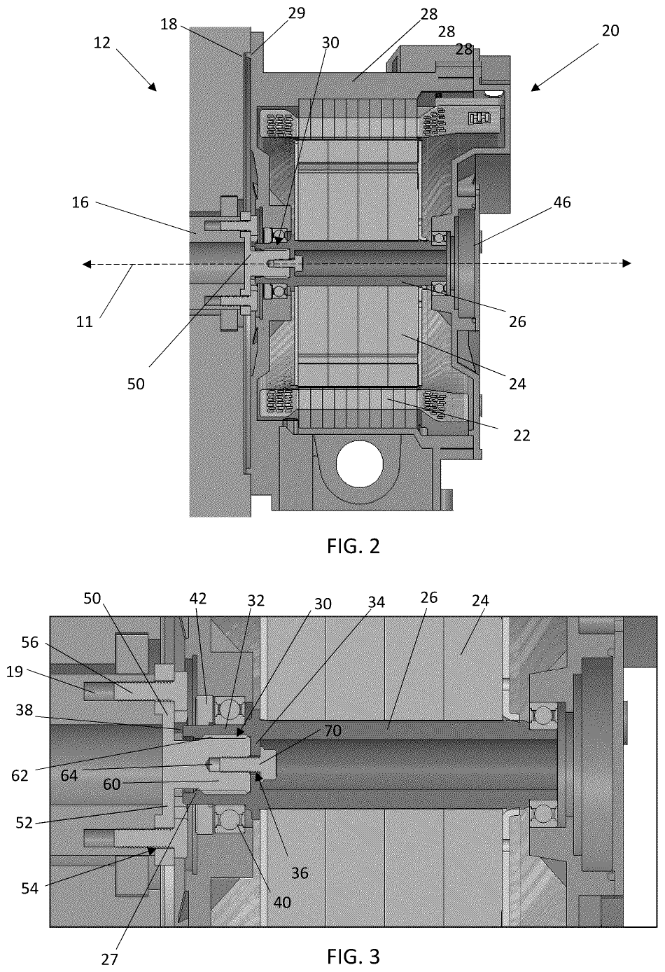

With particular reference now to FIGS. 2 and 3, a first embodiment of the engine adapter 50 is shown. The engine adapter 50 is configured to couple the engine drive shaft 16 (which may also be referred to herein as a “crankshaft”) to a rotor shaft 26 of an electric motor 20. The rotor shaft 26 is rotatably coupled to a rotor 24 of the electric motor 20. A stator 22 is positioned axially around the rotor 24 and the rotor shaft 26. The stator 22 is fixedly secured within a motor housing 28. The motor housing 28 includes a face with a pilot tab 29. A groove 18 on a sidewall of the engine 12 receives the pilot tab 29 such that the electric machine 20 is properly oriented relative to the engine 12 within the vehicle 10.

In the embodiment of FIGS. 2 and 3, the rotor shaft 26 is hollow from end-to-end. A proximal end of the rotor shaft 26 defines a cavity 30 that is configured to receive a portion of the engine adapter 50. The cavity 30 provides a cup-like structure (which may be referred to herein as simply a “cup structure”) with cylindrical sidewalls 32. The interior surface of the sidewalls 32 includes axial splines 27. The exterior surface of the sidewalls 32 is supported by bearings 40. A rim 38 is defined around an open end of the cylindrical sidewalls 32. A base 34 is defined at a closed end of the cylindrical sidewalls that is removed from the rim 38 on an opposite axial side of the cavity 30. The base 34 provides a shoulder within the cavity 30 that limits the distance that the engine adapter 50 can be inserted into the rotor shaft 26. In addition to providing a shoulder, the base 34 also includes a center hole 36 that is sufficiently sized to pass a central shaft bolt 70 there-through, as explained in further detail below.

The engine adapter 50 includes a mount 52 and a knob 60 that protrudes outwardly from the mount 52. The engine adapter 50 is a monolithic structure comprised of steel of other material that is strong, durable and sufficiently heat-tolerant for use in a vehicle engine application.

The mount 52 of the engine adapter 50 is provided by a circular plate. Accordingly, it will be recognized that the mount 52 may alternatively be referred to herein as a “mounting plate.” The mounting plate 52 includes a plurality of bolt holes 54 arranged around the periphery of the plate. A plurality of mounting bolts 56 extend through the bolt holes 54 and into threaded bores 17 in the engine drive shaft (or shaft of a torque converter, if the engine adapter 50 is connected to the torque converter of the engine 12 instead of the drive shaft 16). Therefore, it will be recognized that the mounting bolts 56 are used to secure the engine adapter 50 to the engine 12. Furthermore, the term “bore” as used herein is intended to simply refer to a hole in a component, and is not limited to holes formed with a revolving tool via a boring operation.

The central end knob 60 of the engine adapter 50 is integrally formed with the mount 52. In the embodiment of FIGS. 2 and 3, the knob 60 is a cylindrical structure that protrudes outwardly from the mount 52. The knob 60 is designed and dimensioned to fit within the cavity 30 of the rotor shaft 26. Accordingly, the outer surface of the knob 60 may include axial splines 62. The splines 62 include features to promote interference with the sidewalls 32 in the cavity of the hollow rotor shaft 26. For example, the splines 62 may be helical and/or tapered to assist with engagement with the splines of the sidewalls 32. In at least some embodiments, the splines 62 are cutting splines similar to those on the HVH250 product sold by BorgWarner, Inc. (e.g., see the information available for the HVH 250 at https://www.borgwarner.com/technologies/electric-drive-motors, the contents of which are incorporated herein by reference). For example, the splines 62 may be helical with a taper. In at least some embodiments, removable keys are included on the splines that broach (replace when disassembling the unit vs. whole engine flange).

A central threaded bore 64 is positioned at a distal end of the knob 60. The central threaded bore 64 extends along an axial centerline 11 defined by the engine drive shaft 16 and the rotor shaft 26. The central threaded bore 64 is threaded and configured to receive the central shaft bolt 70. Because the bore 64 is positioned within the knob 60, the entire bore 64 is positioned within the cavity 30 of the hollow rotor shaft 26.

The central shaft bolt 70 (which may also be referred to herein as simply a “center bolt”) is a solitary axial shaft bolt extending along the axial centerline 11 and into the central threaded bore 64 of the knob 60 on the engine adapter 60. A head of the central shaft bolt 70 is positioned on one side of the base 34, and a shaft of the central shaft bolt 70 extends through the center hole 36 of the base 34 and into the central threaded bore 64. As explained in further detail below, because the rotor shaft 26 is hollow, the head of the center shaft bolt 70 may be easily accessed during assembly or disassembly of the electric machine 20 with the engine 12. An end cap 46 is mounted to the motor housing 28, positioned at an end of the rotor shaft 26 opposite the cavity 30, and seals the end of the hollow shaft 26 and prevents access to the shaft bolt 70. It will be recognized that this end cap 46 is removed during assembly and disassembly of the electric machine 20 on the engine.

The axial stack of the unit is configured to handle clearance when bolting down the center shaft bolt 70 (and thus fastening the rotor shaft 26 to the engine adapter 50). The axial stack incorporates at least one wave washer 42 positioned adjacent to bearings 40 that are slip fit to the housing. The wave washers 42 employed between the left bearing and a lip on the housing (not shown) enable axial movement of the rotor shaft 26 as the central shaft bolt is tightened. Similar, at least one wave washer may be positioned between the right bearing and a lip on the housing to compensate for axial tolerance. The axial stack also may further incorporates a selective shim interface (not shown) between male/female spline components (i.e., between the end of the knob 60 and the base 34 of the cavity 30.

### Method of Coupling Electric Machine to Vehicle Engine

It will be appreciated from the foregoing description of the vehicle 10 of FIGS. 1-3 that a method is also disclosed herein for axially fastening an electric machine to a vehicle engine. As noted above, and as shown in FIGS. 2 and 3, the engine adapter 50 is first coupled to the drive shaft 16 by inserting the mounting bolts 56 through the holes 54 around the perimeter of the mount 52 and into threaded holes in the drive shaft 16, and then tightening the mounting bolts 56. The electric machine 20 is then positioned in the vehicle 10 by engaging the cavity 30 of the rotor shaft with the central end knob 60 of the engine adapter 50 and sliding the electric machine 20 toward the engine 12 in the axial direction. As the engine adapter 50 moves further into the cavity 30, the splined sidewalls of the cup structure provided by the cavity 30 engage complementary splines on the central end knob 60.

When the knob 60 of the engine adapter 50 is fully engaged in the cavity 30 of the rotor shaft 26, the pilot tabs 29 of the electric machine 20 are brought into engagement with the groove 18 (or grooves) on the face of the engine 12 (i.e., on the engine bell housing), thus placing the electric machine 20 in the correct position relative to the vehicle engine 12. Mounting bolts (not shown) are inserted in mounting holes (not shown) in the motor housing 28 and screwed into the vehicle engine 12 thereby securing the electric machine 20 to the engine 12. With the electric machine 20 in this position, access to the back side of the electric machine 20 is provided within the vehicle 10 (i.e., at the right side of the rotor shaft 26 as shown in FIGS. 2 and 3). After this, the central shaft bolt 70 is inserted through the length of the hollow shaft 26, through the center hole 36 at the base 34 of the cup structure, and into the central threaded bore 64 in the engine adapter 50. The central shaft bolt 70 is then tightened in the bore 64. During this process, the head of the shaft bolt 70 clamps against the base 34 of the cup structure in the rotor shaft 26 and secures the engine adapter 50 to the rotor shaft 26. The end cap 46 is then secured to the motor housing 28.

As the shaft bolt 70 is tightened to the engine adapter 50, two items of note may occur, depending on the embodiment of the engine adapter and electric machine that is employed. First, the male feature of the engine adapter (i.e., the knob 60) may promote circumferential interference with the hollow rotor shaft 26 and so that when the shaft bolt 70 is tightened there will be no lash. Second, in order to enable this axial movement, shims or wave washers may be employed to avoid excessive cross clamp on the bearings while maintaining good clearance or preload. There may also be a seal under the shaft bolt 70 because the hollow rotor shaft may have oil, and the seal will assist in keeping the engine bell housing dry. This seal can be accomplished via boring with a mating feature in the engine adapter or copper washer, for example.

In order to disassemble the unit, a tool similar to a harmonic balancer puller is utilized. The tool engages the engine adapter 50 and the hollow rotor shaft 26. The above-described method results in a low cost, simple engine/generator attachment that is durable and easy to assemble and disassembly.

Embodiment of Engine Adapter with Conical Knob

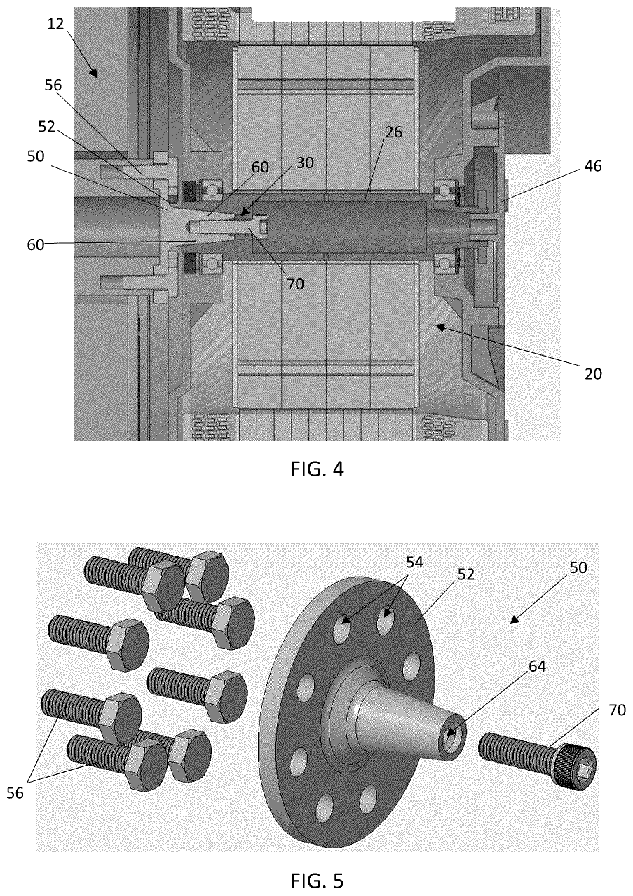

With reference now to FIGS. 4 and 5, an alternative embodiment of the engine adapter 50 and electric machine 20 is shown. This embodiment is similar to the embodiment of FIGS. 2-3, and the engine adapter 50 includes a mount 52, a plurality of bolt holes 54, a plurality of mounting bolts 56, and a central end knob 60 with a central threaded bore 64 configured to receive a shaft bolt 70. However, in the embodiment of FIGS. 4-5, the end knob 60 of the engine adapter 50 is frustoconical in shape and the sidewalls 32 of the cavity 30 have a complementary conical shape configured to receive the end knob 60. This complementary shape allows for a tight friction fit between the end knob 60 and the sidewalls 32, promotes full and easy engagement between the engine adapter 50 and the rotor shaft 26, and reduces the risk of spline wear. A central shaft bolt 70 is also used in this embodiment to promote an even more secure and tight fit between the frustoconical surface of the knob 60 and the sidewalls 32 of the cavity 30. In at least one embodiment, the frustoconical surface further includes some texture or other surfaces features (e.g., splines) that engage complementary surface features on the sidewalls 32 of the cavity 30.

### Embodiment of Engine Adapter Without Central Shaft Bolt

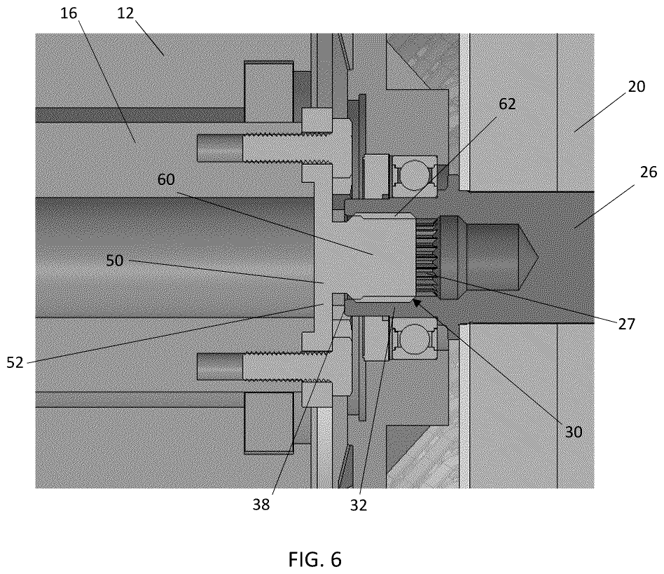

With reference now to FIG. 6 yet another alternative embodiment of the engine adapter 50 and electric machine 20 is shown. This embodiment is similar to the embodiment of FIGS. 2-3, but in the embodiment of FIG. 6, the entire rotor shaft 26 is not hollow, and there is no central shaft bolt. In this embodiment, the cavity 30 at the end of the rotor shaft 26 remains, and the end knob 60 is fit into the cavity 30 with the splines 27 of the cavity 30 engaging splines 62 on the knob 60.

### Embodiment of Monolithic End Knob and Drive Shaft

Another alternative embodiment (not shown), the end knob 60 is formed on the end of the drive shaft, making a monolithic drive shaft and end knob formed of a single unitary component. The end knob 60 includes engaging splines 62 and a threaded bore 64. The mounting bolts 56 and separate adaptor 50 are therefore eliminated. The rest of the components are the same as the previous embodiments.

While several possible embodiments of the apparatus for axial fastening for rotating electrical machines have been disclosed herein, it will be recognized that numerous alternative embodiments and configurations are possible. For example, in at least one alternative configuration, the conical surface of the knob is not smooth, but is splined or includes other texture to further assist in a secure connection between the knob of the engine adapter and the cup structure of the rotor shaft. As another example, the bearings that support the cup structure may be removed in at least some embodiments. As yet another example, the engine adapter may be integrally formed with the drive shaft instead of a separate component that is fixed to the engine drive shaft with bolts or other coupling means.

The foregoing detailed description of one or more embodiments of the method and apparatus of axial fastening for a rotating electric machine has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by any eventually appended claims. Therefore, the spirit and scope of any appended claims should not be limited to the description of the embodiments contained herein.

What is claimed is:

1. A vehicle comprising:
an engine including a drive shaft;
an electric machine connected to the engine, the electric machine including a stator, a rotor and a hollow rotor shaft, the hollow rotor shaft defining an axial centerline; and
a central bolt extending between the hollow rotor shaft and the engine.

2. The vehicle of claim 1 wherein the engine further includes an engine adapter connected to an end of the drive shaft, wherein the central bolt extends between the hollow rotor shaft and the engine adapter.

3. The vehicle of claim 2 wherein the engine adapter is bolted to an end of the drive shaft with a plurality of mounting bolts.

4. The vehicle of claim 2 wherein the engine adapter includes a mount with a plurality of mounting holes and a knob with a central threaded bore configured to receive the center bolt.

5. The vehicle of claim 4 wherein the center bolt is a solitary axial shaft bolt extending along the axial centerline and through a central hole at an end of the hollow rotor shaft and into the central threaded bore in the engine adapter.

6. The vehicle of claim 5 wherein the hole at the end of the hollow rotor shaft is provided in a shoulder that is removed from a rim of the hollow rotor shaft at the proximal end of the hollow shaft.

7. The vehicle of claim 6 wherein the shoulder serves as a base of a cup structure formed at the end of the hollow rotor shaft, wherein the knob of the engine adapter is received within the cup structure such that the central threaded bore is positioned within the knob structure.

8. The vehicle of claim 7 wherein the cup structure includes splined sidewalls that engage complementary splines on the central end knob.

9. The vehicle of claim 7 wherein the central end knob is frustoconical in shape and the cup structure is complementary in shape to the end knob.

10. The vehicle of claim 1, further including an end knob located on an end of the drive shaft and the drive shaft and the end knob are monolithic in construction formed of a single unitary component.

11. The vehicle of claim 1 wherein the electric machine includes a face with a pilot tab and the engine includes a sidewall with a groove configured to receive the pilot tab and orient the electric machine relative to the engine.

12. A vehicle comprising:
an engine including:
a drive shaft defining an axial centerline; and
an engine adapter connected to an end of the drive shaft, the engine adapter including a mount with a plurality of mounting holes, a plurality of bolts extending through the plurality of mounting holes and into the drive shaft, and a central end knob positioned along the axial centerline; and
an electric machine connected to the engine, the electric machine including a stator, a rotor and a rotor shaft extending along the axial centerline, the rotor shaft including a cup structure at an end of the rotor shaft with the central end knob of the engine adapter positioned within the cup structure.

13. The vehicle of claim 12 wherein the cup structure includes splined sidewalls that engage complementary splines on the central end knob.

14. The vehicle of claim 12, wherein the drive shaft is a hollow drive shaft and a base of the cup structure forms a shoulder within the hollow drive shaft.

15. The vehicle of claim 14 wherein a hole extends through the base of the cup structure and an axial shaft bolt extends along the axial centerline and into a threaded bore in the central end knob.

16. The vehicle of claim 15 wherein the central end knob is frustoconical in shape and the cup structure is complementary in shape to the end knob.

17. The vehicle of claim 12 wherein the drive shaft is provided as a shaft of a torque converter of the engine.

18. An engine adapter configured to couple an electric machine to a drive shaft of a vehicle engine, the engine adapter including:
a circular mounting plate with a plurality of mounting holes configured to pass a plurality of bolts through the circular mounting plate;
a knob positioned at a center of the mounting plate and extending outward from the mounting plate, the knob including a threaded bolt hole positioned at a distal end of the knob from the mounting plate; and
a center bolt including a threaded shaft and a head, wherein the threaded bolt hole at the distal end of the knob is configured to receive the threaded shaft.

19. The engine adapter of claim 17 wherein the knob is frustoconical in shape.

20. The engine adapter of claim 17 wherein the knob is splined.
